(19) United States
(12) Patent Application Publication
(10) Pub. No.: US 2017/0041597 A1
(43) Pub. Date: Feb. 9, 2017

(54) HEAD MOUNTED DISPLAY AND METHOD FOR DATA OUTPUT

(71) Applicant: OPTiM CORPORATION, Saga (JP)

(72) Inventor: Shunji SUGAYA, Tokyo (JP)

(21) Appl. No.: 15/162,688

(22) Filed: May 24, 2016

(30) Foreign Application Priority Data
Aug. 3, 2015 (JP) 2015-153271

(51) Int. Cl. H04N 13/04; H04N 13/00; G06T 19/00

(52) U.S. Cl. CPC H04N 13/0484; G06T 19/006; H04N 13/007; H04N 13/0429

(57) ABSTRACT

The present invention is to provide a head mounted display and a method for data output that are capable of identifying and outputting an object displayed as three-dimensional data based on user's line of sight. The head mounted display 10 that covers user's eyes and outputs three-dimensional space data as virtual or augmented reality images a user's eye to detect the user's line of sight; and identifies an object displayed as three-dimensional data based on the detected user's line of sight and outputs the object as interested object data.

### CROSS REFERENCE TO RELATED APPLICATIONS

This application claims priority to Japanese Patent Application No. 2015-153271 filed on Aug. 3, 2015, the entire contents of which are incorporated by reference herein.

### TECHNICAL FIELD

The present invention relates to a head mounted display and a method for data output that cover user's eyes and output three-dimensional space data as virtual or augmented reality.

### BACKGROUND ART

Head mounted displays that cover user's eyes and display three-dimensional space data as virtual or augmented reality have been put to practical use in recent years. Such head mounted displays display various data as virtual or augmented reality.

A head mounted display that displays augmented reality space in which an image is superimposed on real space is disclosed (Refer to Patent Document 1).

### CITATION LIST

### Patent Literature

Patent Document 1: JP 2015-99448A

### SUMMARY OF INVENTION

Patent Document 1 describes that the existence and the orientation of a paper are detected in a real space imaged by a camera and that augmented reality space superimposed on this paper is displayed as an output image simulated by an additional process of a printer that is to be output to the paper or an image according to the shape of this paper

However, the user hardly knows whether or not she or he is actually looking at this paper on which the image is superimposed. Therefore, the user hardly knows whether or not virtual reality or augmented reality is being displayed with an object that the user is looking at.

Then, the present invention focuses on the point that the user can know an object that she or he is looking at, by analyzing user's line of sight and then identifying and outputting the object displayed as three-dimensional data.

An objective of the present invention is to provide a head mounted display and a method for data output that are capable of identifying and outputting an object displayed as three-dimensional data based on user's line of sight.

The first aspect of the present invention provides a head mounted display that covers user's eyes and outputs three-dimensional space data as virtual or augmented reality, including:

an imaging unit that images a user's eye to detect the user's line of sight; and

an interested data output unit that identifies an object displayed as three-dimensional data based on the detected user's line of sight and outputs the object as interested object data.

According to the first aspect of the present invention, a head mounted display that covers user's eyes and outputs three-dimensional space data as virtual or augmented reality images a user's eye to detect the user's line of sight; and identifies an object displayed as three-dimensional data based on the detected user's line of sight and outputs the object as interested object data.

The first aspect of the present invention falls into the category of a head mounted display, but the category of a method for data output has the same functions and effects.

The second aspect of the present invention provides the head mounted display according to the first aspect of the present invention, in which the interested data output unit outputs interested object data associated with location information in three-dimensional space.

According to the second aspect of the present invention, the head mounted display according to the first aspect of the present invention outputs interested object data associated with location information in three-dimensional space.

The third aspect of the present invention provides the head mounted display according to the first aspect of the present invention, in which the interested data output unit outputs the interested object data as text data resulted from image recognition.

According to the third aspect of the present invention, the head mounted display according to the first aspect of the present invention outputs the interested object data as text data resulted from image recognition.

According to fourth aspect of the present invention, a method for data output that covers user's eyes and outputs three-dimensional space data as virtual or augmented reality, including the steps of imaging a user's eye to detect the user's line of sight; and identifying an object displayed as three-dimensional data based on the detected user's line of sight and outputs the object as interested object data.

The present invention can provide a head mounted display and a method for data output that are capable of identifying and outputting an object displayed as three-dimensional data based on user's line of sight.

### BRIEF DESCRIPTION OF DRAWINGS

FIG. 1 shows a schematic diagram of the head mounted display 10.

FIG. 2 shows a configuration diagram of the head mounted display 10.

FIG. 3 shows a functional block diagram of the head mounted display 10.

FIG. 4 shows a flow chart illustrating the output process performed by the head mounted display 10.

FIG. 5 shows image data on a user's eye that the head mounted display 10 images.

FIG. 6 shows the location information storage table that the head mounted display 10 stores.

FIG. 7 shows a virtual reality space that the head mounted display 10 displays.

FIG. 8 shows a user's line of sight that the head mounted display 10 analyzes.

FIG. 9 shows interested object data that the head mounted display 10 displays.

### DESCRIPTION OF EMBODIMENTS

Embodiments of the present invention will be described below with reference to the attached drawings. However, this is illustrative only, and the scope of the present invention is not limited thereto.

### Overview of Head Mounted Display 10

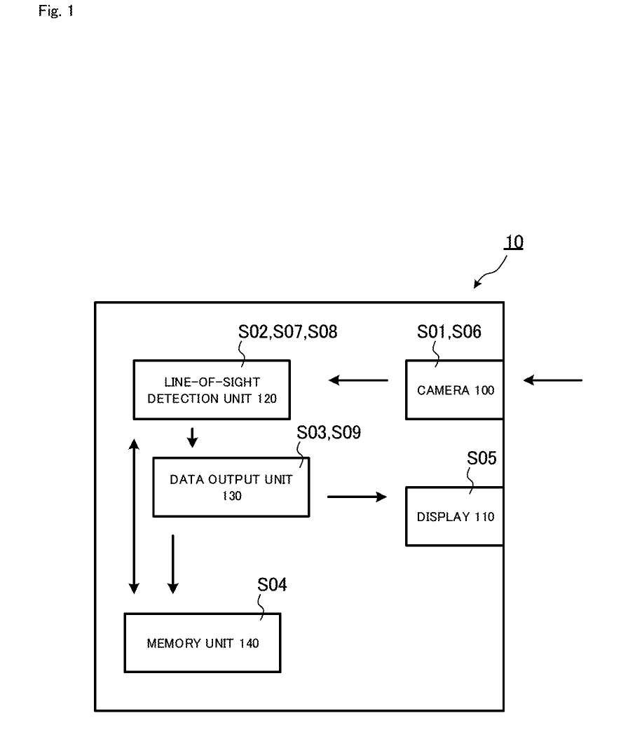

FIG. 1 shows an overview of the head mounted display 10 according to a preferable embodiment of the present invention. The head mounted display 10 includes a camera 100, a display 110, a line-of-sight detection unit 120, a data output unit 130, and a memory unit 140.

The head mounted display 10 covers user's eyes and outputs three-dimensional space data as virtual or augmented reality. The camera 100 includes a device that images a user's eye. The display 110 includes a device that displays three-dimensional space data as virtual or augmented reality. The line-of-sight detection unit 120 includes a device that analyzes image data on the user's eye imaged by a camera 100 and then detects and identifies user's line of sight. The data output unit 130 includes a device that outputs an object existing on the identified user's line of sight and location information of this object in three-dimensional space and also a device that outputs the identified object as text data.

First, the camera 100 images one eye of the user who wears the head mounted display 10 (step S01).

The line-of-sight detection unit 120 analyzes image data on the imaged user's eye and detects and acquires location information of the eye (step S02).

The data output unit 130 generates location information of three-dimensional data to be output to the display 110 (step S03).

The memory unit 140 associates and stores location information of the user's eye acquired by the line-of-sight detection unit 120 with location information of three-dimensional data generated by the data output unit 130 (step S04). In the step S04, the memory unit 140 stores and associates location information on the location of three-dimensional data to be displayed on the display 110 with the location of the user's eye.

The display 110 displays virtual reality space (step S05). In the step S05, the display 110 displays virtual reality space based on the location information of the three-dimensional data generated by the data output unit 130.

The camera 100 images one eye of the user (step S06).

The line-of-sight detection unit 120 analyzes an image of the user's eye that is taken in the step S06 and acquires location information of the eye (step S07). In the step S07, the line-of-sight detection unit 120 acquires the analysis of the location information of the eye based on the location of the iris.

The line-of-sight detection unit 120 acquires location information of the three-dimensional data on an object existing on the user's line of sight based on the acquired location information of the user's eye (step S08).

The data output unit 130 identifies the object existing on the user's line of sight based on the location information of the three-dimensional data that the line-of-sight detection unit 120 has acquired and outputs this object as interested object data (step S09). In the step S09, the data output unit 130 outputs the interested object data to the display 110 and an external terminal, etc., that are communicatively connected with the data output unit 130. In the step S09, the data output unit 130 also outputs the interested object data associated with location information in three-dimensional space. In the step S09, the data output unit 130 also outputs the interested object data as text data resulted from image recognition.

### Configuration of Head Mounted Display 10

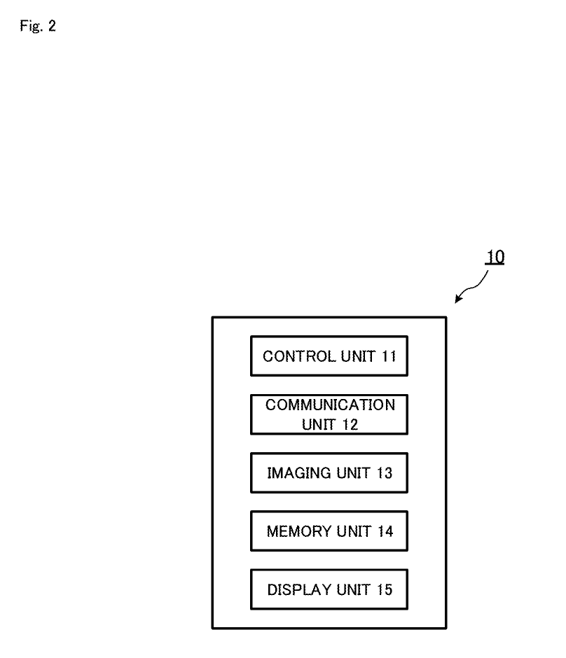

FIG. 2 shows a configuration diagram of the head mounted display 10 according to a preferable embodiment of the present invention. The head mounted display 10 includes a control unit 11, a communication unit 12, an imaging unit 13, a memory unit 14, and a display unit 15.

The head mounted display 10 has the functions to be described later to cover user's eyes and output three-dimensional space data as virtual or augmented reality. The head mounted display 10 includes the communication unit 12 with a data communication function. The head mounted display 10 includes the imaging unit 13 with a device such as a camera that images a user's eye. The head mounted display 10 includes the memory unit 14 that stores various data and information. The head mounted display 10 includes the display unit 15 that displays the images, data, and various types of information that have been controlled by the control unit 11.

The head mounted display 10 also includes a device that analyzes the image of the user's eye taken by the imaging unit 13 and detects the user's line of sight. The head mounted display 10 also includes a device that identifies the object displayed on the display unit 15 as three-dimensional data based on the detected user's line of sight and outputs the object as an interested object. The head mounted display 10 also includes a device that outputs the interested object data associated with location information in three-dimensional space. The head mounted display 10 also includes a device that outputs the interested object data as text data resulted from image recognition.

### Functions

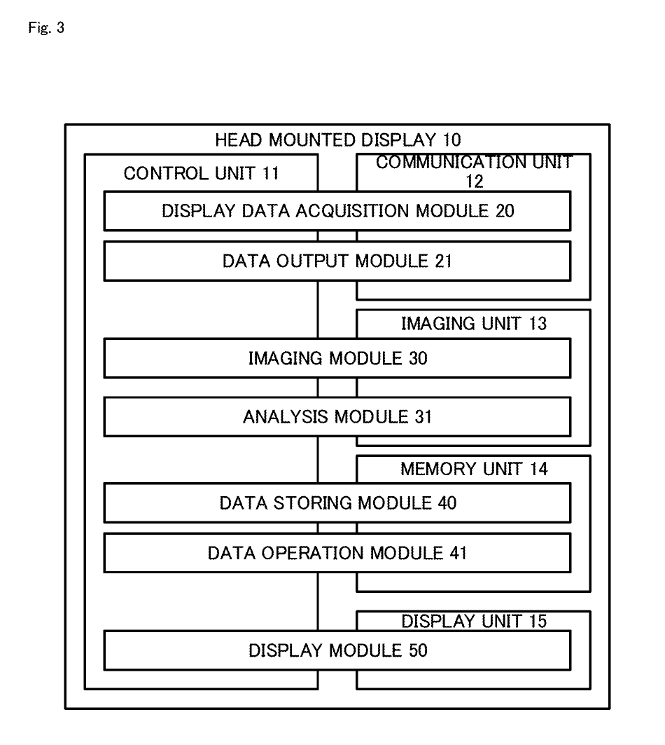

The structures will be each described below with reference to FIG. 3.

The head mounted display 10 includes a control unit 11 provided with a central processing unit (hereinafter referred to as “CPU”), a random access memory (hereinafter referred to as “RAM”), and a read only memory (hereinafter referred to as “ROM”); and a communication unit 12 such as a device capable of communicating with other devices, for example, a Wireless Fidelity or Wi-Fi® enabled device complying with IEEE 802.11.

The head mounted display 10 also includes an imaging unit 13 that takes an image, for example, a camera. The head mounted display 10 also includes a memory unit 14 such as a hard disk, a semiconductor memory, a record medium, or a memory card to store data. The memory unit 14 includes an interested object table and a text data table that are to be described later.

The head mounted display 10 also includes a display unit 15 that outputs and displays data and images controlled by the control unit 11.

In the head mounted display 10, the control unit 11 reads a predetermined program to run a display data acquisition module 20 and a data output module 21 in cooperation with the communication unit 12. Furthermore, in the head mounted display 10, the control unit 11 reads a predetermined program to run an imaging module 30 and an analysis module 31 in cooperation with the imaging unit 13. Yet furthermore, in the head mounted display 10, the control unit 11 reads a predetermined program to run a data storing module 40 and a data operation module 41 in cooperation with the memory unit 14. Yet still furthermore, in the head mounted display 10, the control unit 11 reads a predetermined program to run a display module 50 in cooperation with the display unit 15.

### Data Output Process

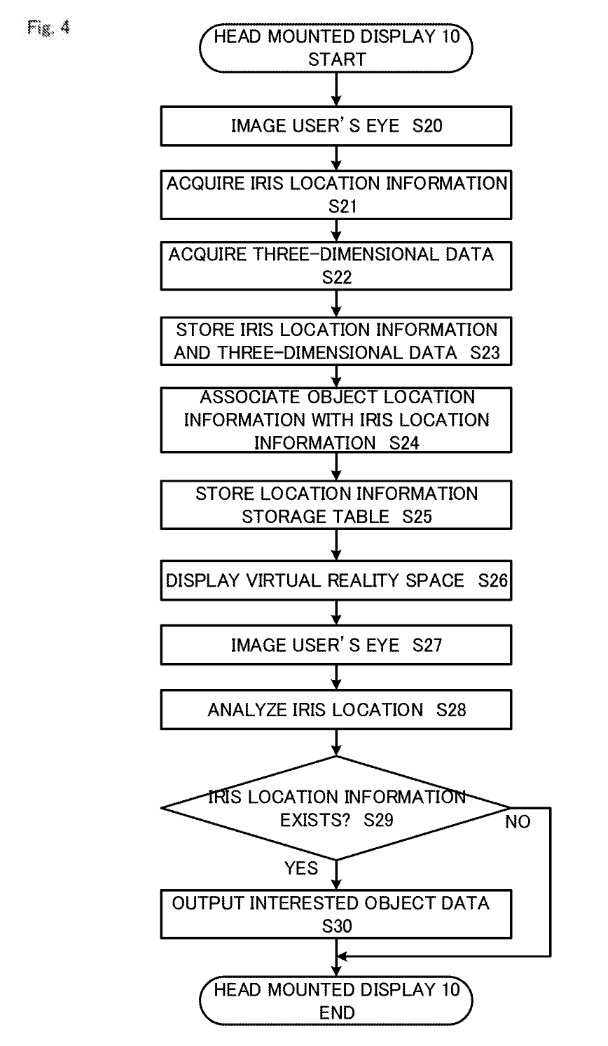

FIG. 4 shows a flow chart illustrating the output process performed by the head mounted display 10. The tasks executed by the modules of each of the above-mentioned units will be explained below together with this process.

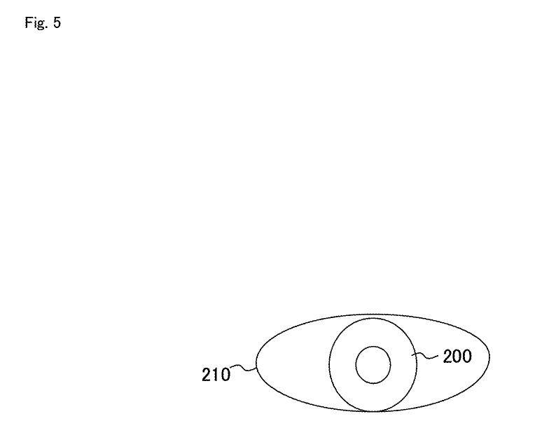

First, the imaging module 30 of the head mounted display 10 images one eye of the user who wears the head mounted display 10 (step S20). In the step S20, the imaging module 30 takes an image of the eyeball and the eyelid of a user's eye as shown in FIG. 5.

The analysis module 31 of the head mounted display 10 analyzes the image taken in the step S20 and acquires the location of the iris 200 in the taken image as iris location information (step S21). In the step S21, the analysis module 31 uses the inner corner of the user's eye 210 as a reference point and acquires the location of the iris 200 as coordinates.

The display data acquisition module 20 of the head mounted display 10 acquires three-dimensional data as virtual data on the three-dimensional space to be displayed on the head mounted display 10 (step S22). In the step S22, the display data acquisition module 20 acquires three-dimensional data from a server, a mobile terminal, an external terminal such as a computer for home or business use, which are communicatively connected with the head mounted display 10.

The data storing module 40 of the head mounted display 10 stores iris location information acquired in the step S21 and three-dimensional data acquired in the step S22 (step S23).

The data operation module 41 of the head mounted display 10 associates object location information on the location, etc. of each object contained in the three-dimensional data with the iris location information (step S24) based on the stored three-dimensional data. In the step S24, the data operation module 41 operates the locational relation of the iris location information and the object location information. For example, the location of user's iris 200 and then the object location information and the iris location information when the user is looking at the displayed building A are operated and calculated.

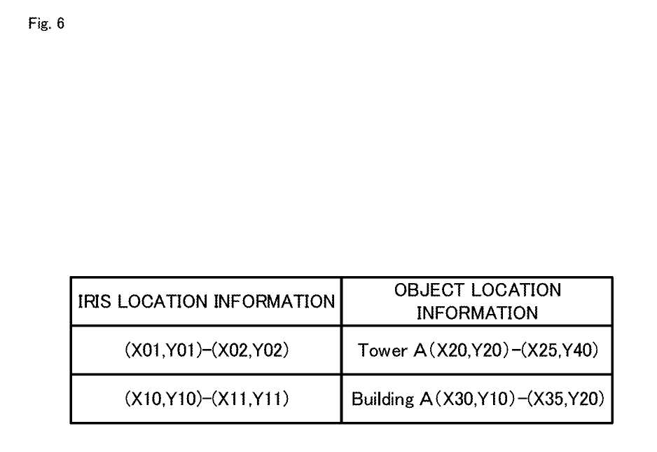

The data storing module 40 of the head mounted display 10 associates and stores the iris location information with the object location information that are calculated in the step S24, in the location information storage table shown in FIG. 6 (step S25).

### Location Information Storage Table

FIG. 6 shows the location information storage table that the data storing module 40 of the head mounted display 10 stores. The data storing module 40 associates and stores the iris location information indicating the location of a user's iris 200 with the object location information indicating the name and the location information of an object. In FIG. 6, the data storing module 40 associates and stores (X01,Y01)-(X02,Y02) as iris location information with the tower A (X20,Y20)-(X25,Y40) as object location information. The data storing module 40 also associates and stores (X10,Y10)-(X11,Y11) as iris location information with the building A (X30,Y10)-(X35,Y20) as object location information. The data storing module 40 also associates and stores object location information of other objects existing in the three-dimensional space data with iris location information in the same way. The data storing module 40 may associate and store object location information of other objects with iris location information. The data storing module 40 may also associate and store iris location information with images based on the three-dimensional data.

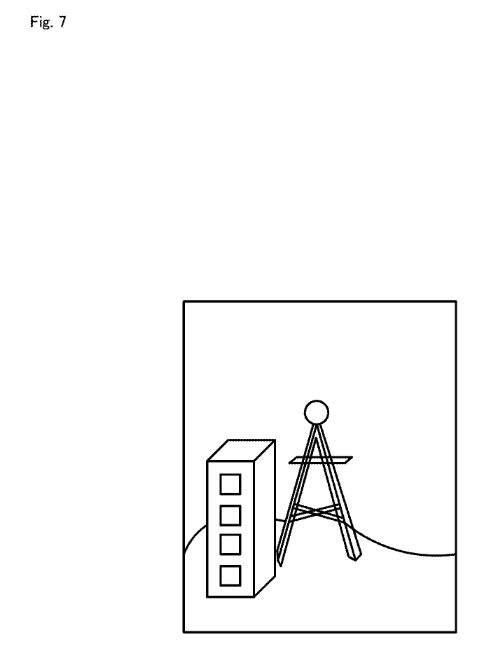

The display module 50 of the head mounted display 10 displays the virtual reality space shown in FIG. 7 based on the three-dimensional data acquired in the step S22 (step S26). In FIG. 7, the display module 50 displays the building A and the tower A as virtual reality space. Needless to say, the virtual reality space that the display module 50 displays may be other objects. The virtual reality space that the display module 50 displays can be appropriately changed.

The imaging module 30 of the head mounted display 10 images one eye of the user who wears the head mounted display 10 (step S27). The step S27 is processed in the same way as the above-mentioned step S20.

The analysis module 31 of the head mounted display 10 analyzes the location of the user's iris 200 imaged in the step S27 (step S28). In the step S28, the analysis module 31 uses the location of the inner corner of the user's eye 210 in image data on the imaged eye as a reference point and analyzes the iris location information indicating the location of the iris 200 as coordinates. The analysis module 31 analyzes the user's line of sight based on the analyzed iris location information.

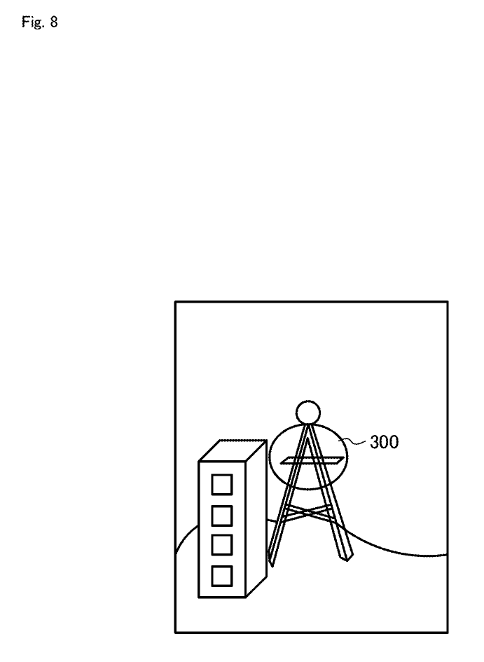

The analysis module 31 of the head mounted display 10 recognizes the user's line of sight 300 in the three-dimensional data that the display module 50 displays, as shown in FIG. 8.

In the step S28, the analysis module 31 retrieves iris location information stored by the data storing module 40 based on the iris location information analyzed by the analysis module 31 and judges the existence of an object on the user's line of sight (step S29).

In the step S29, if judging no existence of the analyzed iris location information in the stored iris location information (NO), the analysis module 31 ends this process. On the other hand, if judging the existence of the analyzed iris location information in the stored iris location information (YES) in the step S29, the data output module 21 of the head mounted display 10 outputs the object location information associated with this iris location information as interested object data (step S30).

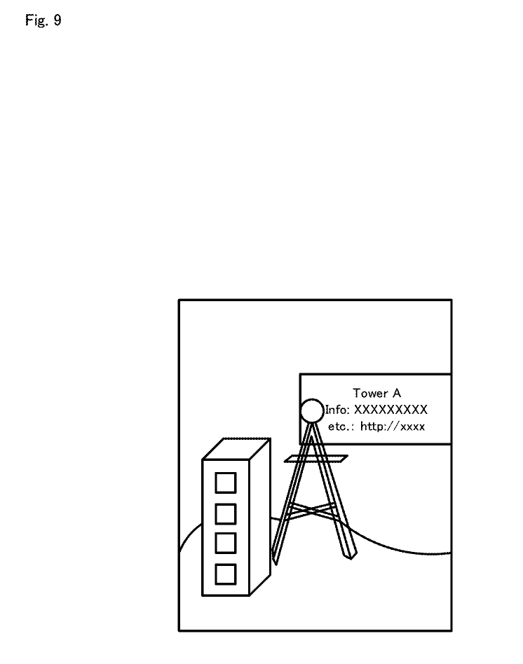

In the step S30, the data output module 21 outputs location information, text data on a name, a type, etc., and text data resulted from image recognition that are contained in this object location information, as interested object data. The data output module 21 also outputs the interested object data to the display module 50, an external terminal, a different head mounted display, etc. For example, if the data output module 21 outputs the interested object data to the display module 50, the display module 50 displays various data such as text data and image data on an enlarged image on the user's line of sight as shown in FIG. 9. If the data output module 21 outputs the interested object data to an external terminal, the display module 50 displays the identifier and the username of the head mounted display 10 and various data such as text data and image data on the enlarged image of an object existing the line of sight of the user of the head mounted display 10 on this external terminal. If the data output module 21 outputs the interested object data to a different head mounted display, the display module 50 displays the identifier and the username of the head mounted display 10 and various data such as text data and image data on the enlarged image of an object existing on the line of sight of the user of the head mounted display 10 in a part of the display of the different head mounted display or in a position corresponding to location information contained in the object location information.

FIG. 9 shows interested object data that the display module 50 of the head mounted display 10 displays. In FIG. 9, the display module 10 displays the name, the information, and other items of an object. The name of an object is of the object on the user's line of sight. The information includes various kinds of information associated with this object. For example, this information includes various types of information on this object that the display data acquisition module 20 acquires through a public line network, etc. The other items include a URL address as the search result achieved after the display data acquisition module 20 retrieves this object as a key word. For example, the display module 50 may display the enlarged image, other information, etc., of an object.

To achieve the means and the functions that are described above, a computer (including a CPU, an information processor, and various terminals) reads and executes a predetermined program. For example, the program is provided in the form recorded in a computer-readable medium such as a flexible disk, CD (e.g. CD-ROM), and DVD (e.g. DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, and a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

10 head mounted display

What is claimed is:

1. A head mounted display that covers user's eyes and outputs three-dimensional space data as virtual or augmented reality, comprising:
an imaging unit that images a user's eye to detect the user's line of sight; and
an interested data output unit that identifies an object displayed as three-dimensional data based on the detected user's line of sight and outputs the object as interested object data.

2. The head mounted display according to claim 1, wherein the interested data output unit outputs interested object data associated with location information in three-dimensional space.

3. The head mounted display according to claim 1, wherein the interested data output unit outputs the interested object data as text data resulted from image recognition.

4. A method for data output that covers user's eyes and outputs three-dimensional space data as virtual or augmented reality, comprising the steps of:
imaging a user's eye to detect the user's line of sight; and
identifying an object displayed as three-dimensional data based on the detected user's line of sight and outputs the object as interested object data.
